(19) United States
(12) Patent Application Publication
(10) Pub. No.: US 2003/0081014 A1
(43) Pub. Date: May 1, 2003

(54) Method and apparatus for assisting the reading of a document

(76) Inventor: David Mark Frohlich, Bristol (GB)

Correspondence Address: HEWLETT-PACKARD COMPANY, Intellectual Property Administration, P.O. Box 272400, Fort Collins, CO, 80527-2400, US

(21) Appl. No.: 10/283,135

(22) Filed: Oct. 30, 2002

(30) Foreign Application Priority Data
Oct. 31, 2001 (GB) 0126204.7

(51) Int. Cl. G09G 5/00

(52) U.S. Cl. 345/856

(57) ABSTRACT

Computer apparatus for assisting the reading of a document by displaying upon it a chronologic sequence of pointing gestures, comprises a camera and data processor for imaging the document and for tracking the movement of a pointer, such as a person's finger, over the document to associate that movement with the imaged document as the said sequence, and a computer with a projector for displaying the sequence in association with a reproduction of the same document, which may be printed paper or an on-screen image, normally at a remote location for conferencing.

A photograph on a two dimensional medium comprises a computer-readable representation of such a chronologic sequence of pointing gestures associated with the photograph.

### BACKGROUND OF THE INVENTION

This invention relates to a method and apparatus for assisting the reading of a document, such as a printed or scribed document or a photograph, with applications for synchronous electronic conferencing and for asynchronous handling of documents using memory devices.

The purpose of the invention is to attach significance to the content of a document such as a printed or scribed paper document, or a photograph. This is required particularly for remote conferencing, where conferencing parties are in audio communication using telephony or video links. Both parties have access to the same document or to a reproduction of the document, for example on paper or on screen, and the content of the document is being discussed.

Current document conferencing tools adopt an approach in which paper source material is converted into electronic form, transmitted to a remote site and displayed on a screen for sharing. For example a scanned document can be viewed in a shared document application using Microsoft NetMeeting (registered trade mark). Whilst this allows shared viewing of the document on the screen, it does not support the kind of manual document handling typical of comparable face to face situations. Here a variety of paper documents can be moved around a horizontal work surface, continuously re-orientated, pointed to with the fingers, and marked with a pen or pencil. These displays also make the current technology expensive.

Current document messaging tools are typically separate products, which convert paper source material into electronic form for screen display or printing, as in the e-mailing or faxing of scanned documents. Whilst several published studies show that such messages are enhanced by voice annotation, and animated writing and pointing, all known solutions for adding such data are screen based rather than paper based: examples are the Lotus ScreenCam product and the Wang Freestyle prototype (described in “Human-machine interactive systems”, edited by Allen Clinger, published by Plenum Publishing Corporation, 1991). A further example is the Hewlett Packard “Voicefax” prototype described in the report “Voicefax: a shared workspace for voicemail partners”, Frohlich and Daly-Jones, companion proceedings of CHI′95:308-9.

In the context of a rather different medium, photography, there have also been proposals to play back audio clips from printed photographs, for example, the applicants' International Patent Application Publication No. WO00/03298.

Thus one of the purposes of the present invention is to support document conferencing in the pure paper medium, and to support a combined messaging and conferencing solution which fits in with the natural ebb and flow of synchronous and asynchronous contact typical of remote social interaction. A further aim is to enhance the use of audio photographs.

### SUMMARY OF THE INVENTION

Accordingly, the invention provides apparatus for assisting the reading of a document by displaying upon it a chronologic sequence of pointing gestures, comprising means for imaging the document and for tracking the movement of a pointer over the document to associate that movement with the imaged document as the said sequence, and means for displaying the sequence in association with a reproduction of the same document.

Preferably, the means for imaging the document comprises a camera focussed on a real two dimensional medium on which the document is printed or scribed, and a processor linked to the camera for processing an image captured by the camera, and for orientating the image using predetermined registration criteria.

Preferably, the image processing means is arranged to identify the position of the pointer in the captured image and thereby to track it.

In one example, the apparatus comprises a synchronous communications system between source and destination processors, the source processor being arranged to read the document and track the sequence of pointing gestures, and the destination processor being arranged to display the said sequence over the reproduction of the same document.

Preferably the destination processor has means for receiving an electronic version of the document and for printing it as the said reproduction.

Alternatively, the destination processor has means for receiving an electronic version of the document and for displaying it visually as the said reproduction.

Optionally, the apparatus comprises a memory for storing the image of the document and the said associated sequence, and a processor for reproducing the stored sequence on the reproduction of the document.

As an alternative, the apparatus has means for transmitting the image of the document and the associated sequence to a remote memory, such as an internet website, for use by a processor for reproducing the stored sequence on the reproduction of the document.

In another aspect, the invention provides a method of assisting the reading of a document by displaying upon it a chronologic sequence of pointing gestures, comprising imaging the document and tracking the movement of a pointer over the document to associate that movement with the imaged document as the said sequence, and displaying the sequence in association with a reproduction of the same document.

The invention also provides a document such as a photograph on a two dimensional medium comprising a computer-readable representation of a chronologic sequence of pointing gestures associated with the document.

In the context of document reproduction or photography, the invention also provides apparatus for viewing such a document or photograph comprising a projector for displaying the said sequence over the document or photograph.

The document or photograph may have an audio memory integrated with the medium, and it may also have a transducer for generating an aural reproduction from that audio memory. Alternatively, it may simply store a code representative of an audio sequence stored elsewhere but accessible by the apparatus for reproduction. Preferably then the viewing apparatus has means for simultaneously playing back the aural reproduction from the audio memory, in association with the said sequence.

The invention also consists in a computer program arranged to control a processor associated with such apparatus, the program controlling the imaging of the document and the tracking of the movement of the pointer, and the association of that movement with the imaged document as the said sequence.

Correspondingly, the invention also consists in a computer program arranged to control a processor in such apparatus, the program controlling the displaying of the sequence in association with a reproduction of the said document.

### BRIEF DESCRIPTION OF THE DRAWINGS

In order that the invention may be better understood, some embodiments of the invention will now be described, by way of example only, with reference to the accompanying diagrammatic drawings, in which:

FIG. 1 is a simplified system architecture diagram for use at one location of a conferencing system;

FIG. 2 is a planned view of a printed paper document with calibration marks and a page identification mark;

FIG. 3 is a close-up planned view of one of the calibration marks;

FIG. 4 is a close-up planned view of the page identification mark comprising a two-dimensional bar code;

FIG. 5 is a flowchart demonstrating the operation of the system for capturing and orientating the document;

FIG. 6 is a schematic diagram of a conferencing system for two parties, each of which uses a system as seen in FIG. 1;

FIG. 7 is a diagram of a modified conferencing system;

FIG. 8 is a diagram of a further modified conferencing system; and

FIG. 9 is a planned view of a printed paper document with a pointer mark projected upon it.

### DESCRIPTION OF THE PREFERRED EMBODIMENTS

In its application to electronic conferencing, the invention requires an interface between a document on a two-dimensional medium, and a processor, and this has to detect the orientation of the document in accordance with pre-determined registration criteria such as printed registration marks or the edges of the document.

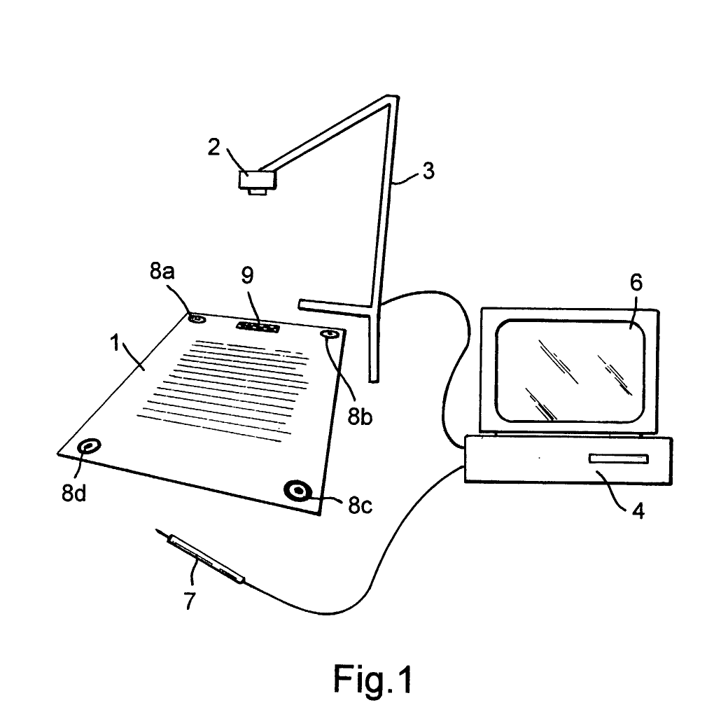

Referring firstly to FIG. 1, this illustrates a graphical input system set up for operation. The system/apparatus comprises, in combination, a printed or scribed document 1, which might, for example, be a sheet of paper that is a printed page from a holiday brochure; a video camera 2 that is held above the document 1 by a stand 3 and focuses down on the document 1; a computer 4 to which the camera 2 is linked, the computer suitably being a conventional PC having an associated VDU/monitor 6; and a pointer 7 with a pressure sensitive tip and which is linked to the computer 4.

The document 1 differs from a conventional printed brochure page in that it bears a set of four calibration marks 8a-8d, one mark 8a-d proximate each corner of the page, in addition to a two-dimensional bar code which serves as a readily machine-readable page identifier mark 9 and which is located at the top of the document 1 substantially centrally between the top edge pair of calibration marks 8a, 8b.

The calibration marks 8a-8d are position reference marks that are designed to be easily differentiable and localisable by the processor of the computer 4 in the electronic images of the document 1 captured by the overhead camera 2.

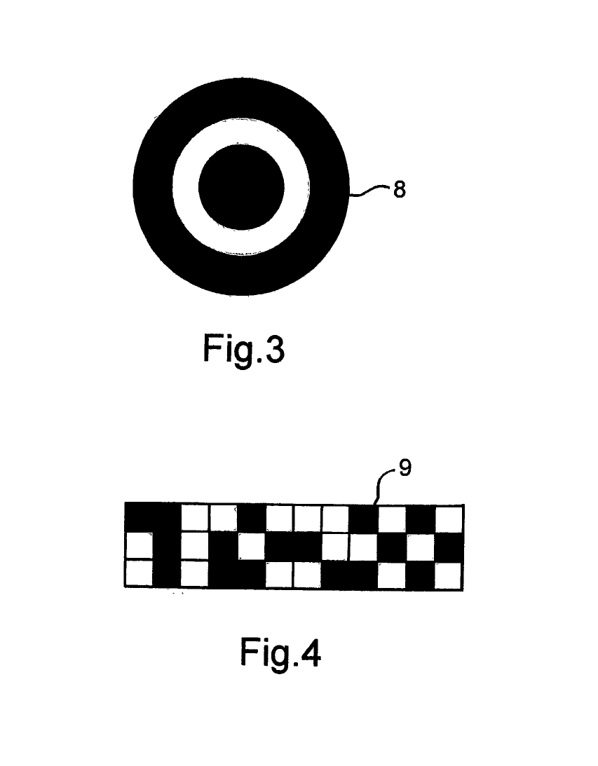

The illustrated calibration marks 8a-8d are simple and robust, each comprising a black circle on a white background with an additional black circle around it as shown in FIG. 3. This gives three image regions that share a common centre (central black disc with outer white and black rings). This relationship is approximately preserved under moderate perspective projection as is the case when the target is viewed obliquely.

It is easy to robustly locate such a mark 8 in the image taken from the camera 2. The black and white regions are made explicit by thresholding the image using either a global or preferably a locally adaptive thresholding technique. Examples of such techniques are described in:

Gonzalez R & Woods R Digital Image Processing, Addison-Wesley, 1992, pages 443-455; and Rosenfeld A & Kak A Digital Picture Processing (second edition), Volume 2, Academic Press, 1982, pages 61-73.

After thresholding, the pixels that make up each connected black or white region in the image are made explicit using a component labelling technique. Methods for performing connected component labelling/analysis both recursively and serially on a raster by raster basis are described in: Jain R, Kasturi R & Schunk B Machine Vision, McGraw-Hill, 1995, pages 42-47 and Rosenfeld A & Kak A Digital Picture Processing (second edition), Volume 2, Academic Press, 1982, pages 240-250.

Such method explicitly replace each component pixel with a unique label.

Black components and white components can be found through separate applications of a simple component labelling technique. Alternatively it is possible to identify both black and white components independently in a single pass through the image. It is also possible to identify components implicitly as they evolve on a raster by raster basis keeping only statistics associated with the pixels of the individual connected components (this requires extra storage to manage the labelling of each component).

In either case what is finally required is the centre of gravity of the pixels that make up each component and statistics on its horizontal and vertical extent. Components that are either too large or too small can be eliminated straight off. Of the remainder what we require are those which approximately share the same centre of gravity and for which the ratio of their horizontal and vertical dimensions agrees roughly with those in the calibration mark 8. An appropriate black, white, black combination of components identifies a mark 8 in the image. Their combined centre of gravity (weighted by the number of pixels in each component) give the final location of the calibration mark 8.

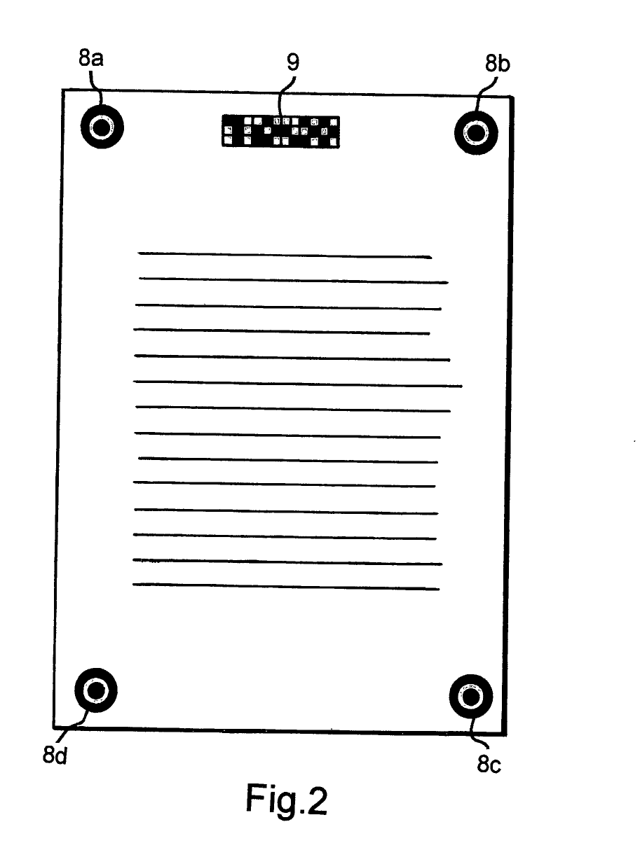

The minimum physical size of the calibration mark 8 depends upon the resolution of the sensor/camera 2. Typically the whole calibration mark 8 must be more than about 60 pixels in diameter. For a 3MP camera 2 imaging an A4 document there are about 180 pixels to the inch so a 60 pixel target would cover ⅓ of an inch. It is particularly convenient to arrange four such calibration marks 8a-d at the corners of the page to form a rectangle as shown in the illustrated embodiment of FIG. 2.

For the simple case of fronto-parallel (perpendicular) viewing it is only necessary to correctly identify two calibration marks 8 in order to determine the location, orientation and scale of the documents. Furthermore for a camera 2 with a fixed viewing distance the scale of the document 1 is also fixed (in practice the thickness of the document, or pile of documents, affects the viewing distance and, therefore, the scale of the document).

In the general case the position of two known calibration marks 8 in the image is used to compute a transformation from image co-ordinates to those of the document 1 (e.g. origin at the top left hand corner with the x and y axes aligned with the short and long sides of the document respectively). The transformation is of the form:

$$[ \begin{matrix}{X}^{′} \\ {Y}^{′} \\ 1\end{matrix} ] = [ \begin{matrix}k cos θ & - sin θ & {t}_{x} \\ sin θ & k cos θ & {t}_{y} \\ 0 & 0 & 1\end{matrix} ] [ \begin{matrix}X \\ Y \\ 1\end{matrix} ]$$

Where (X, Y) is a point in the image and (X′, Y′) is the corresponding location on the document (1) with respect to the document page co-ordinate system. For these simple 2D displacements the transform has three components: an angle θ a translation (tₓ, t_{y}) and a overall scale factor k. These can be computed from two matched points and the imaginary line between them using standard techniques (see for example: HYPER: A New Approach for the Recognition and Positioning of Two-Dimensional Objects, IEEE Trans. Pattern Analysis and Machine Intelligence, Volume 8, No. 1, January 1986, pages 44-54).

With just two identical calibration marks 8a, 8b it may be difficult to determine whether they lie on the left or right of the document or the top and bottom of a rotated document 1 (or in fact at opposite diagonal corners). One solution is to use non-identical marks 8, for example, with different numbers of rings and/or opposite polarities (black and white ring order). This way any two marks 8 can be identified uniquely.

Alternatively a third mark 8 can be used to disambiguate. Three marks 8 must form an L-shape with the aspect ratio of the document 1. Only a 180 degree ambiguity then exists for which the document 1 would be inverted for the user and thus highly unlikely to arise.

Where the viewing direction is oblique (allowing the document 1 surface to be non-fronto-parallel or extra design freedom in the camera 2 rig) it is necessary to identify all four marks 8a-8d in order to compute a transformation between the viewed image co-ordinates and the document 1 page co-ordinates.

The perspective projection of the planar document 1 page into the image undergoes the following transformation:

$$[ \begin{matrix}x \\ y \\ w\end{matrix} ] = [ \begin{matrix}a & b & c \\ b & e & f \\ g & h & 1\end{matrix} ] [ \begin{matrix}X \\ Y \\ 1\end{matrix} ]$$

Where X′=x/w and Y′=y/w.

Once the transformation has been computed then it can be used for a range of purposes which may include firstly assisting in locating the document page identifier bar code 9 from expected co-ordinates for its location that may be held in a memory in or linked to the computer 4. The computed transformation can also be used to map events (e.g. pointing) in the image to events on the page (in its electronic form).

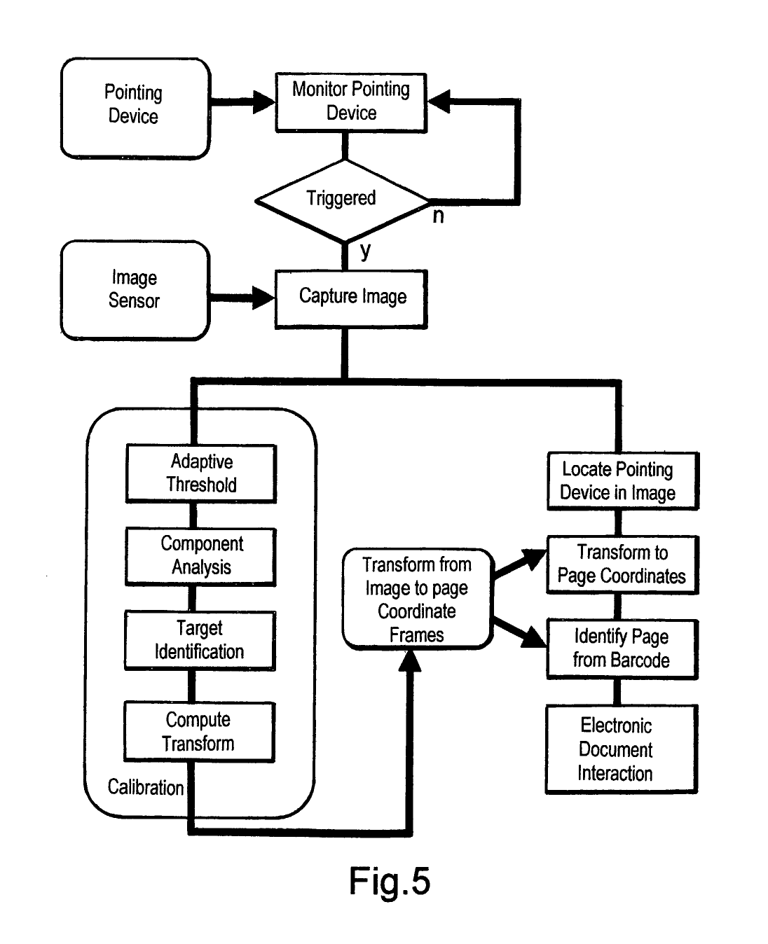

The flow chart of FIG. 5 shows a sequence of actions that are suitably carried out in using the system and which is initiated by triggering a switch associated with a pointing device 7 for pointing at the document 1 within the field of view of the camera 2. The triggering causes capture of an image from the camera 2, which is then processed by the computer 4.

As noted above, the apparatus comprises a tethered pointer 7 with a pressure sensor at its tip that may be used to trigger capture of an image by the camera 2 when the document 1 is tapped with the pointer 7 tip. This image is used for calibration, calculating the mapping from image to page co-ordinates; for page identification from the barcode 9; and to identify the current location of the end of the pointer 7.

The calibration and page identification operations are best performed in advance of mapping any pointing movements in order to reduce system delay.

The easiest way to identify the tip of the pointer 7 is to use a readily differentiated and, therefore, readily locatable and identifiable special marker at the tip. However, other automatic methods for recognising long pointed objects could be made to work. Indeed, pointing may be done using the operator's finger provided that the system is adapted to recognise it and respond to a signal such as tapping or other distinctive movement of the finger or operation of a separate switch to trigger image capture.

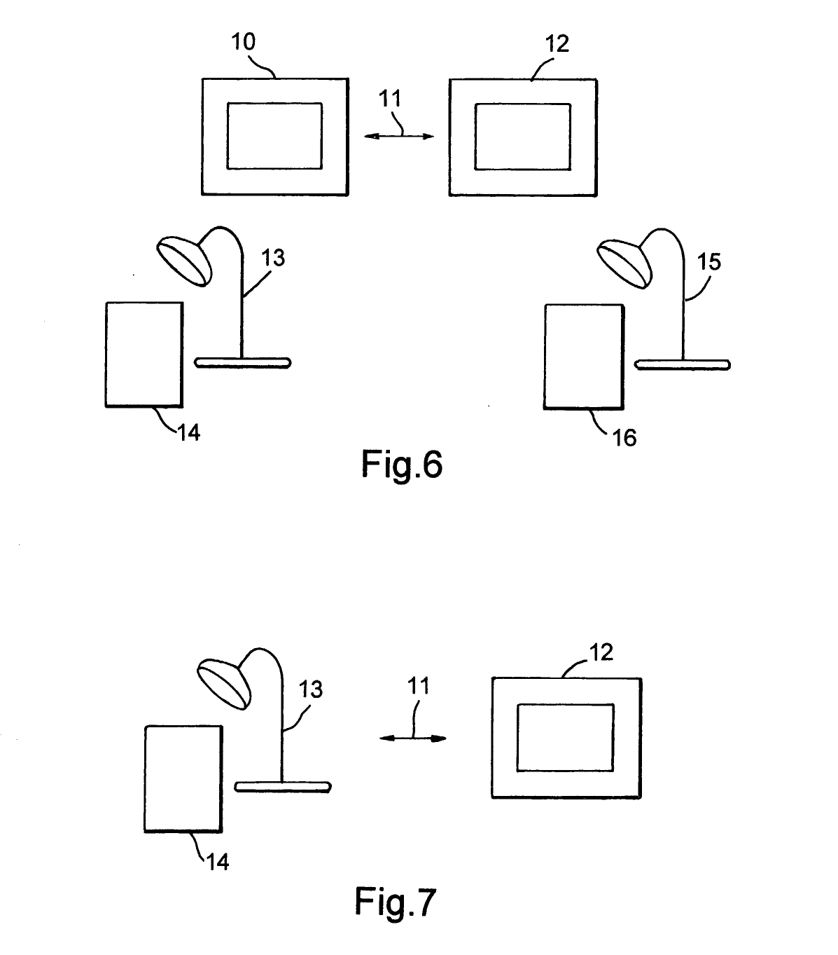

Embodiments of the invention, for synchronous electronic conferencing over a communications system, are illustrated in FIGS. 6 to 8.

In the embodiment shown in FIG. 6, two personal computers (PCs) are allowed to communicate in a conventional manner over a communications system shown schematically by the arrow 11, which may for example be through the internet or a wide area network. The source PC 10 includes processing software for capturing and orientating the document, and for identifying and tracking a chronologic sequence of pointing gestures associated with that document 14. A viewing arrangement 13 adjacent the document 14 corresponds to the camera 2 and stand 3 of FIG. 1, and may comprise for example a face up “desk lamp” scanner peripheral such as the Vesta Pro-Scan product from Philips. The document 14 may have the registration and identification marks 8, 9 described above, or some other means for identifying and/or orientating the document.

Each PC 10, 12 runs conferencing and e-mail software. This allows, where necessary, an image of the document 14 to be printed by a printer connected to the destination PC 12, and reproduced as document 16. This however is not always necessary, because the documents 14 and 16 may already be available to both conferencing parties. The conferencing system allows the parties to communicate orally and optionally also by video.

In order to provide the visual chronologic sequence of gestures, they are projected onto the destination document 16 by the lamp 15. For this purpose, the scanner/lamp head has an integrated remote controlled laser pointing mechanism (not shown). This projects a bright image which reflects from the surface of the medium 16. One example of this is shown in FIG. 9, in which the laser projects an image of a small arrow 17. Alternatives would be a simple spot, but any shape could be used.

In this synchronous mode of operation, the scanned document 14 is transmitted to the remote location 12 for printing and sharing. Specialised image processing software at the source site 10 tracks live pointing gestures on the source document 14 to control the direction of laser pointing at the destination site, on the reproduction of that document 16. Image processing software at the destination site 12 adjusts the received pointing co-ordinates, if the remote document 16 is moved out of alignment with the lamp 15. This enables the conferencing party at the destination 12 to see a live dot or other pointer travelling across the document 16, which corresponds for example to the tip of the index finger of a conferencing party at the source PC 10. Ideally, the gestures are transmitted in both directions, so that the finger movements of each conferencing party are relayed simultaneously to the other conferencing party. Obviously other pointing devices could be used instead of index fingers, such as ballpoint pens, or the pointer 7 described above.

With simultaneous communication by voice, this allows the parties to add useful visual information to particular parts of the relevant document, so it assists in the reading and interpretation of the document. In some circumstances, it may be desirable to provide a record of handwriting movements used by one or other of the conferencing parties on the document 14, 16. The handwriting movements could then be detected and recorded as a continuous sequence of the position of the tip of the pointer; recorded, and displayed by the laser pointer which can be made to oscillate at a frequency sufficient to give the illusion of a stable line, i.e. greater than around 20 Hz. In this way, a permanent or semi-permanent handwritten image can be displayed over the document, as well as a sequence of pointing gestures.

In the alternative arrangement or mode of operation shown in FIG. 7, the destination document is reproduced on the PC screen 12, and not on any physical medium such as paper. The sequence of gestures on the source document 14 is transmitted over the communications link 11 to the PC 12, and is immediately reproduced synchronously on the image of the document on screen.

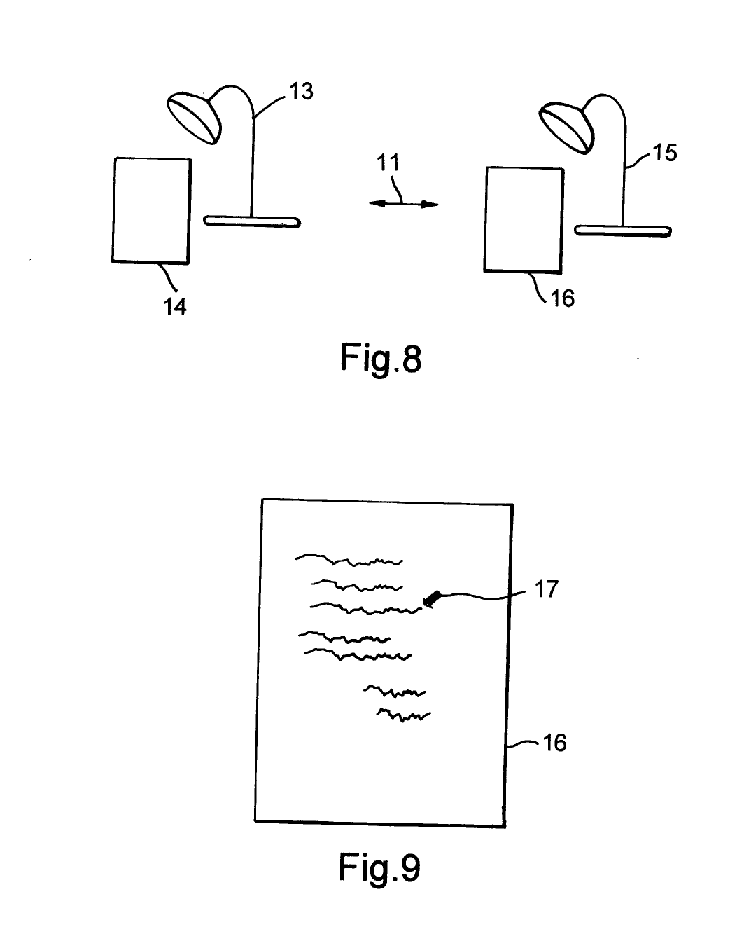

It is anticipated that the necessary processing could be carried out by a processor integrated into the desk lamp 13, 15, as shown schematically in FIG. 8. It is not necessary to provide a further visual indication on any VDU screen or monitor, and in this example the conferencing could be carried out by telephone, for example.

The system of FIG. 8 could be used in conjunction with a printer connected to the desk lamp processor 15, to enable a reproduction of the source document 14 to be obtained at the remote location.

It will be appreciated that this system could be used asynchronously. A record of the chronologic sequence of pointing gestures could be stored either in the PC 10 or in a commonly accessible remote location such as an internet website. This sequence could be played back at a different time, for example through the PC 12 of FIG. 6 or FIG. 7, or the integrated lamp and processor 15 of FIG. 8. Where the processor is integrated into the lamp, such as in FIG. 7 and FIG. 8, there may also be an integrated memory for the sequence.

Real documents may of course contain two or more pages, and such multi-page documents require pages to be turned. The system lends itself to a natural form of communication between conferencing parties as to the turning of pages. One of the recorded gestures may be pre-determined to be indicative of a page turn, and this may be interpreted by the conferencing party himself, or automatically by the destination processor, automatically to turn the page. When playing back a recorded sequence asynchronously, each page is read to determine whether there is any associated message including any sequence of pointing gestures: the system may be programmed to skip such “blank” pages either immediately or after a pre-determined duration. The system may be programmed to provide an indication, visually or aurally, of the need to turn to the next page, or of the fact that there is no message associated with the current page.

The invention also has applications in audio photography. An audio photograph is a medium reproducing an image photographically, and also containing either an audio sequence or a label or code identifying a remotely stored audio sequence, associated with the photographic image. The photograph may even include an integrated transducer for playing back the recorded audio sequence.

The audio photograph may be viewed by placing it in front of a reader such as the camera arrangement 13 of FIGS. 6 to 8. In the case of a compilation of photographs in an album, the photograph required to be viewed may be indicated by a finger or other pointing device, which is then recognised by the processor. The stored audio, or audio label, is read and the audio sequence is generated concurrently with the viewing of the photograph. In accordance with the invention, pointing gestures are recorded as a chronologic sequence in association with the photographic image, and the system described in relation to any of FIGS. 6 to 8 maybe employed to generate such a sequence. Alternatively, such a sequence could be generated by a digital camera with an appropriate pointing device. In any event, it is preferable to associate in time the sequence of pointing gestures with the audio sequence, to give full meaning to the content of the photograph. The projecting device described above in relation to FIGS. 6, 7 or 8 may be used to move a visual pointer over the photograph whilst it is being viewed and whilst the audio sequence is played back.

The invention may be used in many different ways, and the examples given above are not exhaustive. The PC infrastructure of FIGS. 6 and 7 could be replaced by an all-in-one scanner, printer and fax device communicating over a telephone network. The PC based architecture could also be replaced with a web-based one in which an image website could serve as a central storage repository. Any type of document could have the pointing gestures, and optionally also the audio store or label, recorded in computer-readable form on it or in it.

The laser pointer mechanism could be replaced with a specialised light box underneath the document.

The finger tracking could be facilitated by wearing a visually distinctive thimble or ring on the pointing finger.

As described in connection with FIGS. 1 to 5, image recognition can be facilitated by printing each scanned image with a unique visible bar code which is easier to detect and match than by using the printed content of the document. Alternatively a separate bar code sensor can be built into the device and activated by a distinct user action on the printout.

The system could be adapted to accept and to relay image-and-voice data pre-recorded on other devices such as audio photographs recorded on an audio-enabled camera. This would then allow both the local and remote playback of audio from printed photographs.

It will be appreciated that live discussion of multi media messages is possible by supporting concurrent play back and recording of audio information in the conferencing mode. In the context of photography, this could support the remote sharing of audio photos.

What is claimed is:

1. Apparatus for assisting the reading of a document by displaying upon it a chronologic sequence of pointing gestures, comprising means for imaging said document to form an imaged document and for tracking the movement of a pointer over said document to associate that movement with said imaged document as said sequence, and means for displaying said sequence in association with a reproduction of the same document.

2. Apparatus according to claim 1, in which the means for imaging the document comprises a camera focussed on a real two dimensional medium on which the document is printed or scribed, and a processor linked to the camera for processing an image captured by the camera, and for orientating the image using predetermined registration criteria.

3. Apparatus according to claim 2, in which the image processing means is arranged to identify the position of the pointer in the captured image and thereby to track it.

4. Apparatus according to claim 1, comprising a synchronous communications system and source and destination processors, linked by said communications system, the source processor being arranged to read the document and track the sequence of pointing gestures, and the destination processor being arranged to display the said sequence over the reproduction of the same document.

5. Apparatus according to claim 4, in which the destination processor has means for receiving an electronic version of the document and for printing it as the said reproduction.

6. Apparatus according to claim 4, in which the destination processor has means for receiving an electronic version of the document and for displaying it visually as the said reproduction.

7. Apparatus according to claim 1, comprising a memory for storing the image of the document and the said associated sequence, and a processor for reproducing the stored sequence on the reproduction of the document.

8. Apparatus according to claim 1, comprising means for transmitting the image of the document and the associated sequence to a remote memory, such as an internet website, for use by a processor for reproducing the stored sequence on the reproduction of the document.

9. A method of assisting the reading of a document by displaying upon it a chronologic sequence of pointing gestures, comprising imaging the document and tracking the movement of a pointer over the document to associate that movement with the imaged document as the said sequence, and displaying the sequence in association with a reproduction of the same document.

10. A method according to claim 9, for synchronous electronic conferencing over a communications system, comprising transmitting the said sequence of pointing gestures over the communications system.

11. A method according to claim 10, further comprising transmitting an image of the document over the communications system.

12. A method according to claim 11, further comprising printing a reproduction of the document from the transmitted image of that document, and then projecting the said chronologic sequence of pointing gestures onto the printed reproduction.

13. A document on a two dimensional medium comprising a computer-readable representation of a chronologic sequence of pointing gestures associated with the document.

14. A document according to claim 13, further comprising an audio memory on the two-dimensional medium, capable of aural reproduction when viewing the document and whilst displaying the said sequence over the document.

15. A document according to claim 14, in which the medium comprises a transducer for generating the aural reproduction.

16. A document according to claim 13, including a code representative of an audio sequence stored elsewhere, and capable of aural reproduction when viewing the document and whilst displaying the said sequence over the document.

17. A photograph on a two dimensional medium comprising a computer-readable representation of a chronologic sequence of pointing gestures associated with the photograph.

18. Apparatus for viewing a document or a photograph according to any of claims 13 to 17, comprising a projector for displaying the said sequence over the document or photograph.

19. Apparatus according to claim 18, comprising means for simultaneously playing back the aural reproduction from the audio memory, in association with the said sequence.

20. Apparatus according to claim 1, for assisting the reading of a multi-page document, some or all of which pages may have a respective said sequence of gestures associated with them, comprising means responsive to the presence or absence of such sequence to provide an indication whether there is such a sequence.

21. Apparatus according to claim 1 for assisting the reading of a multi-page document, some or all of which pages may have a respective said sequence of gestures associated with them, in which the said sequence or sequences comprise an indication of when to turn to the next page.

22. Apparatus according to claim 20, in which the said sequence comprises a trigger for turning automatically to the next page.

23. A computer program arranged to control a processor associated with the apparatus of claim 1, the program controlling the imaging of the document and the tracking of the movement of the pointer, and the association of that movement with the imaged document as the said sequence.

24. A computer program arranged to control a processor in apparatus according to claim 1, the program controlling the displaying of the sequence in association with a reproduction of the said document.

25. Apparatus for assisting the reading of a paper document, comprising means for imaging the paper document to form an imaged document and for tracking the movement of a pointer over the paper document to associate that movement with the imaged document as a chronologic sequence of pointing gestures, and means for displaying said chronologic sequence in association with a reproduction of the same document.

26. Apparatus for assisting the reading of a paper document, comprising means for imaging the paper document to form an imaged document and for tradking the movement of a pointer over the paper document to associate that movement with the imaged document as a chronologic sequence of pointing gestures, and means for displaying said chronologic sequence on a reproduction on paper of the same document.

27. Apparatus for assisting the reading of a document by displaying upon it a chronologic sequence of pointing gestures, comprising optical apparatus for imaging the document to form an imaged document, and for tracking the movement of a pointer over the document, a processor responsive to said optical apparatus to associate said movement with said imaged document as said sequence, and computer apparatus for displaying said sequence in association with a reproduction of the same document.

28. Apparatus according to claim 27, in which the optical apparatus for imaging the document comprises a camera focussed on a real two dimensional medium on which the document is printed or scribed, and a processor linked to the camera for processing an image captured by the camera, and for orientating the image using predetermined registration criteria.

29. Apparatus according to claim 28, in which the image processing means is arranged to identify the position of the pointer in the captured image and thereby to track it.

30. Apparatus according to claim 27, comprising a synchronous communications system and source and destination processors linked by said communications system, the source processor being arranged to read the document and track the sequence of pointing gestures, and the destination processor being arranged to display the said sequence over the reproduction of the same document.

31. Apparatus according to claim 30, in which the destination processor has means for receiving an electronic version of the document and for printing it as the said reproduction.

32. Apparatus according to claim 30, in which the destination processor has means for receiving an electronic version of the document and for displaying it visually as the said reproduction.

33. A method of assisting the reading of a document by displaying upon it a chronologic sequence of pointing gestures, comprising imaging, at a first location, the document and tracking the movement of a pointer over the document to associate that movement with the imaged document as the said sequence, and displaying, at a second location remote from said first location, the sequence in association with a reproduction of the same document.

34. A method according to claim 33, for synchronous electronic conferencing over a communications system, comprising transmitting the said sequence of pointing gestures over the communications system between said first and second locations.

35. A method according to claim 34, further comprising transmitting an image of the document over the communications system.

36. A method according to claim 35, further comprising printing a reproduction of the document from the transmitted image of that document, and then projecting the said chronologic sequence of pointing gestures onto the printed reproduction.

37. Apparatus for assisting the reading of a paper document, comprising optical apparatus for imaging the paper document to form an imaged document and for tracking the movement of a pointer over the paper document to associate that movement with the imaged document as a chronologic sequence of pointing gestures, and computer apparatus for displaying said chronologic sequence in association with a reproduction of the same document.

38. Apparatus for assisting the reading of a paper document, comprising optical apparatus for imaging the paper document to form an imaged document and for tracking the movement of a pointer over the paper document to associate that movement with the imaged document as a chronologic sequence of pointing gestures, and computer apparatus for displaying said chronologic sequence on a reproduction on paper of the same document.
